(19) United States
(12) Patent Application Publication
(10) Pub. No.: US 2009/0206175 A1
(43) Pub. Date: Aug. 20, 2009

(54) Hands-free fluid application system

(76) Inventors: Robert Salvagno, Vero Beach, FL (US); Diane Salvagno, Vero Beach, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/069,981

(22) Filed: Feb. 14, 2008

(51) Int. Cl. B05B 9/08

(52) U.S. Cl. 239/154

(57) ABSTRACT

A hands-free fluid application system for retaining a fluid supply close to the body of an operator of the present inventive system. A fluid supply hose may attach to a belt component at a connecting means. The connecting means serves to communicate the fluid to a dispensing hose that then conducts the fluid to a spray applicator for dispersal. The connecting means secured to the belt allows for the fluid supply hose to be dragged along by the operator's body thereby leaving their hands free to operate the spray applicator and direct the stream of fluid issuing therefrom. A spray applicator holder may serve to secure the spray applicator to the belt and allow an operator free use of both hands when manipulation of the spray applicator is not required. The present invention eliminates the repetitive crouching and bending commonly associated with use of a conventional fluid supply hose.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to a fluid application system, more specifically, the present invention relates to a fluid application system allowing for unencumbered movement of an operator wherein the fluid application system is secured close to the operator's body.

2. Background Art

Fluid application is critical to a wide variety of functions including car washing, landscaping, gardening, gutter cleaning, patio cleaning, the cleaning of industrial and manufacturing facilities, and the like. As an operator and the attached conventional fluid spray device move around the work area, the fluid supply hose from a source (e.g. a garden hose) may become entangled with the operator or with other objects in the work area. The operator may often lose sight of the fluid supply hose and then must expend a great deal of energy in continually locating the hose and bending down to retrieve the hose and spray nozzle from the ground. These occurrences create aggravating time delays and result in a great deal of fatigue for the operator. A need exists for a fluid application system that prevents the supply hose from becoming either continually placed on the ground or entangled with the operator or other objects in the work area.

In such situations, it is highly beneficial to maintain a fluid dispersal device on the body of a user to eliminate work stoppages, such as the locating and retrieving of a garden hose placed on the ground, which may be very time consuming, physically arduous, and costly in terms of labor.

Reduction of both labor time and the overall exertion level required by a user in such situations is very beneficial. From routine yard maintenance to elderly individuals that still enjoy gardening, the reduction of physical exertion such as the repetitive bending to grab a garden hose nozzle or the awkward dragging of the garden hose about the yard may be a crucial and determinative factor as to the strenuousness and/or feasibility of performing the task. The present invention is also very beneficial in commercial and/or industrial settings where repetitive cleaning of the surrounding environment or object therein may be a continuous daily activity.

Safety and the ability to multitask may also be relevant issues if free use of one's hands is essential to the situation. For example, a person cleaning gutters may be required to continuously climb up and down a ladder to retrieve and use the garden hose during the cleaning process. Using a ladder or scaffolding is inherently dangerous, and the task becomes all the more perilous when at least one of the user's hands must be used to carry the garden hose while climbing up and down the ladder or scaffolding. In such a situation, a system is required for efficiently and effectively securing the hose to the user's body while at the same time freeing both hands to reduce the risk of danger, such as injury from a fall. Additionally, the freeing of both hands allows the operator to perform other tasks while still having quick and convenient access to a fluid supply source.

Elimination of repetitive movements may further serve to drastically reduce the overall work time. By making steps incorporating the continuous application of fluid more efficient, workers may become much more productive and thereby finish projects in a timelier manner.

Therefore, there is a need felt in the art for a fluid application system that permits a fluid supply hose to be secured to a belt of an operator. Such a system would assist in reducing the physical burden imposed on an operator having to continuously bend down to retrieve and thereafter drag a fluid supply hose to the operator's ever-changing position.

Such a system further promotes safety by preventing falls that may result from an operator having to repeatedly go up and down ladders or scaffolding with a fluid supply hose and/or other tools in his or her hand; the operator may now dispose the fluid supply hose and all other tools on the belt of the present inventive system.

It is an objective of the present invention to provide a fluid application system that serves to free a user's hands for other tasks and/or safety concerns. The system may provide for securing of a fluid supply hose as well as other commonly used items about the waist of the operator, thereby keeping the operator's hands free while moving about a work area, up and/or down ladders or scaffolding, and the like. The present inventive system further enhances the safety of the operator during activities benefiting from easy access to a fluid supply source while reducing wasted time, labor costs, and effort.

### BRIEF SUMMARY OF THE INVENTION

In accordance with the present invention, a fluid application system wherein a fluid is delivered to the fluid application system by a fluid supply hose, the fluid application system comprising a belt sized to secure the fluid application system around the waist or hip of an operator, a connecting means secured to the belt, wherein the connecting means is in communication with and releasably secured to the fluid supply hose, a dispensing hose having a first end and a second end, wherein the first end of the dispensing hose communicates with the connecting means, and a spray applicator in communication with the second end of the dispensing hose.

The present invention provides a fluid application system wherein the operator does not carry or bear the weight of a supply reservoir during the fluid dispersal process. More particularly, the invention provides a connecting means attachment point for the end of a fluid supply hose, the fluid supply hose may be removably attached to an operator's body to permit the fluid supply hose to be dragged along by the operator's body thereby leaving their hands free to operate the spray applicator and direct the stream of fluid issuing therefrom.

The present invention also provides a fluid application system comprising a belt, a connecting means, a dispensing hose, and a spray applicator that may all be quickly and easily coupled together, by the operator in the field, in preparation for immediate fluid application for a multitude of tasks. A quick release connections disposed at each component junction may further assist in this expedited process.

The present invention further provides a spray applicator that may be formed in a variety of shapes to furnish an easy to grip applicator that is available for a variety of uses. A nozzle tip having a multi-positional head may provide for a variety of fluid dispersal configurations including streaming, spraying, misting, and the like. The spray applicator may provide a means of controlling the fluid flow (e,g. on/off control) issuing forth from the present inventive system. Such capability may provide for painless use by individuals with arthritic conditions, carpal tunnel syndrome, and the like. Lack of such functionality may preclude such individuals from participating in any tasks that require fluid application.

It is an important aspect of the present invention to provide a simple and inexpensive fluid supply hose attachment permitting the fluid supply hose to be pulled along by a person's body while the spray applicator may be secured to the belt of the present invention leaving an operator's hands free to perform any other task(s) without separating themselves from the fluid supply.

These and other benefits and advantages will become more apparent to those skilled in the art upon reviewing the summary of this invention, and upon undertaking a study of the description of its preferred embodiments in view of the drawings.

### BRIEF DESCRIPTION OF THE DRAWINGS

FIG. 1 depicts a perspective view of an embodiment of the present inventive system.

FIG. 2 depicts an exploded view of another embodiment of the present inventive system.

FIG. 3 depicts a perspective view of another embodiment of the present inventive system further comprising at least one attachment means.

FIG. 4 depicts a perspective view of another embodiment of the present inventive system further comprising suspenders.

FIG. 5 depicts a perspective view of another embodiment of the present inventive system having components disposed with the belt.

### DETAILED DESCRIPTION OF THE INVENTION

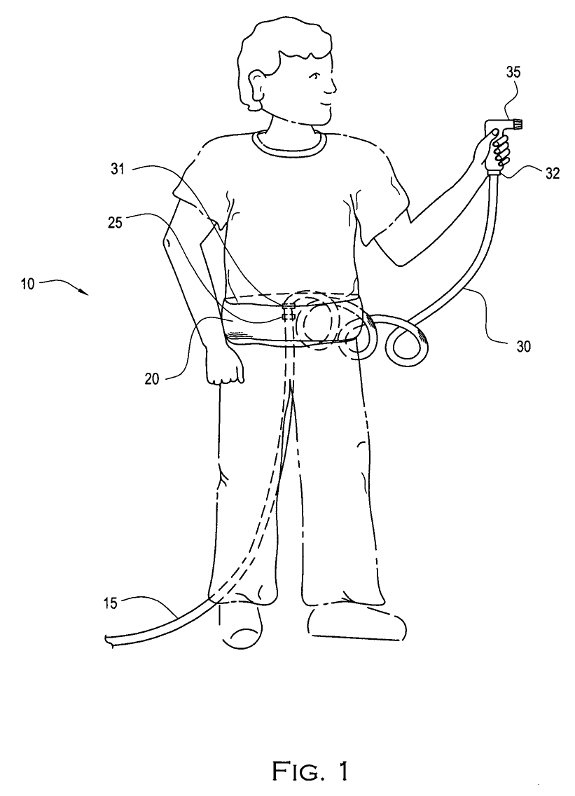

In referring to the Figures, and in particular FIG. 1, there is disclosed a fluid application system 10 for delivering a fluid originating from a fluid supply hose 15 (shown as a ghost image). An operator may have a fluid application system 10 of the present invention attached about their waist or hip. The system 10 may generally comprise a belt 20, a connecting means 25, a dispensing hose 30, and a spray applicator 35. As can be seen from FIG. 1, the fluid supply hose 15 may communicate with the connecting means 25 disposed on the belt 20. The connecting means 25 may then also be in communication with a first end 31 of the dispensing hose 30 which may also have the spray applicator 35 disposed at the second end 32 of the dispensing hose 30.

The fluid supply hose 15 that interacts with the present invention may comprise any form of fluid supply known within the art. The fluid supply hose 15 may originate from a variety of fluid sources including but not limited to a city water supply, a well water supply, a fluid-filled tanker truck, industrial fluid containers, and the like.

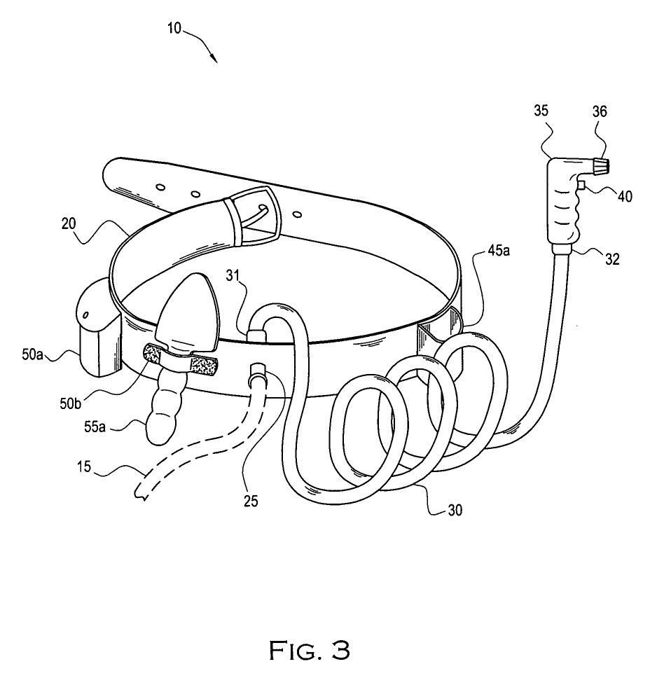

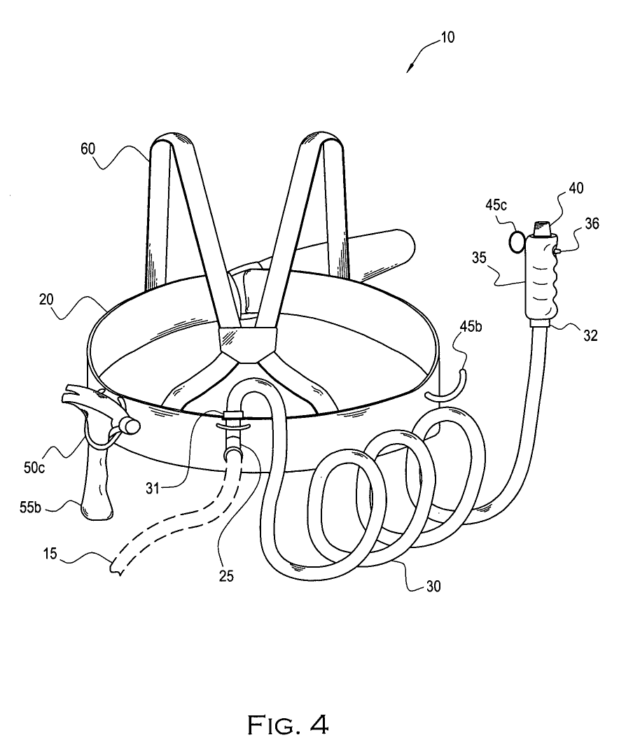

As can be seen in FIGS. 1-4, the present system 10 is secured about the waist or hip of an operator by means of the belt 20. Most people are accustomed to wearing a belt 20 and thus most operators may find such a configuration comfortable to wear. In addition, the belt 20 may be secured firmly so that movement of the present inventive system 10 is minimal. Simple belts 20 may be suitably made from a webbing material, but other functional or hard wearing materials may be easily substituted. The belt 20 may comprise any material known within the arts including but not limited to nylon, leather, rubber, and the like. As depicted in FIGS. 3 and 4, the belt 20 may include a fastening means including but not limited to any fastening means known within the art, belt buckles (see FIG. 3), hook and loop fasteners (see FIG. 4), buttons, snap fasteners, zippers, tie off ends, clasps, clamps, side release buckles, slide fasteners, roller buckles, cam buckles, ladder locks, D-rings, O-rings, and the like. The preferred fastening means comprised hook and loop fasteners as depicted in FIG. 4. The belt 20 may be fully adjustable to fit operators of various sizes via an adjustment bracket or any other means of belt adjustment known within the art.

As depicted in FIGS. 1, 3, and 4, the connecting means 25 may preferably be disposed at the approximate midpoint of the belt 20 such that the connecting means 25 may be adjacent the lower back region of the operator. Such a configuration allows the operator to walk, climb or perform other activities while the fluid supply hose 15 is both supported by the belt 20 and dragged along behind the operator's body. This configuration maintains the path of the fluid supply hose 15 close to and behind the operator's body, thereby preventing the fluid supply hose 15 from entering the working path of the operator. In this manner, the operator's arms and hands are free to use the spray applicator 35, grip a ladder or scaffolding, or perform any other necessary duties in the work area. The present inventive system 10 distributes the weight and drag force of the fluid supply hose 15 over the operator's entire body, especially his or her legs, greatly reducing fatigue. In addition, any risk of dropping the fluid supply hose 15 is eliminated. Within the scope of the present invention, alternate embodiments may include the connecting means 25 disposed at any point about the circumference of the belt 20.

Should the fluid supply hose 15 need to be disengaged rapidly, its point of communication with the connecting means 25 may comprise a quick release mechanism or any other rapidly removable connection known within the art. Any and all other connection points of the system 10, including the connecting means 25 to the dispersing hose 30, and the dispersing hose 30 to the spray applicator 35 may also comprise a quick release mechanism or any other rapidly removable connection known within the art. Such removable connections may include but are not limited to threaded surfaces, quick release mechanisms, or any other engagement configurations known within the art. In a preferred embodiment, the connecting means 25 comprises a male quick release structure disposed thereon and the associated fluid supply hose 15 comprises a complimentary female quick release structure disposed thereon. In this manner, fluid flow from the fluid supply hose 15 is stopped once the system 10 of the present invention is disconnected from the fluid supply hose 15. The complimentary engagement surfaces, including quick release mechanisms, threaded surfaces, and the like, may all be reversed, if desired, within the scope of the present invention. As depicted in FIGS. 1-4, in a preferred embodiment the body of the connecting means 25 may be provided for in a 90 degree configuration. However, the body of the connecting means 25 may be provided for in a variety of embodiments including but not limited to bodies having any structural angle between and including 0 to 180 degrees. Such connecting means 25 may be secured to the belt in any orientation possible. The present invention further includes a fluid conduit channel disposed within the belt 20 for providing passage of fluid between the fluid supply hose 15 and the first end 31 of the dispensing hose 30.

While FIGS. 1, 3, and 4 each depict the connecting means 25 disposed in the approximate midpoint of the belt 20, the connecting means 25 (and connection site for the fluid supply tube 15) may be disposed at any point along the length of the belt 20. In certain work environments, the preferred location of the connecting means 25 may be adjacent the left or right hip of the operator. One embodiment of the present inventive system 10 may comprise a fixed location of the connecting means 25 in regards to the belt 20. The scope of the present invention system 10 also encompasses a connecting means 25 having a releasable attachment to the belt 20 and thereby providing for one or more adjustable points of releasable attachment to the belt 20. Points of attachment may include but are not limited to clips, straps, brackets, one or more apertures through the belt 20, and the like. Additionally, in a preferred embodiment of the present invention the connecting means 25 may be disposed within the material comprising the belt 20 and thereby providing a more aesthetic and streamlined appearance. In such an embodiment, the connecting surfaces of the connecting means 25 may protrude from the surface of the belt 20 providing for attachment thereto.

As depicted in FIGS. 1-4, a dispensing hose 30 connects the connecting means 25 to the spray applicator 35. A first end 31 of the dispensing hose 30 may be releasably secured to the connecting means 25 while a second end 32 of the dispensing hose 30 may be releasably secured to the spray applicator 35. The connections at both ends 31,32 of the dispensing hose 30 may comprise any form of connection known within the art including but not limited to complimentary threaded surfaces and quick release mechanisms. The dispensing hose 30 provides a means for allowing easy manipulation of the spray applicator 35 while maintaining the weight and drag of the fluid supply hose 15 on the operator's torso. Such a dispensing hose 30 may comprise any form of hose or tubing known within the art.

The use of a flexible coiled dispensing hose, as depicted in FIGS. 1-4, may significantly reduce the risk of the dispensing hose 30 either tangling or getting caught up in either the operator or any other object in the work area. Preferably, a flexible coiled dispensing hose 30 of the present invention may be sufficiently flexible to extend when in use but may also have sufficient resilience or rigidity to return automatically to its condensed, compact form when not in use by the operator. Such a flexible dispensing hose 30 may be suitably made of a nylon or similar material with “memory” characteristics (i.e. it has the property of returning to its former shape after flexing). This characteristic may provide for a springy, recoiling action of the flexible coiled dispensing hose 30.

A further advantage of using such a flexible coiled dispensing hose 30 is that if a suitable length of coil is employed, it may prevent the spray applicator 35 from falling to the ground if it is dropped or otherwise accidentally knocked from the operator's hand. If the dispensing hose 30 is of a short enough length, the spray applicator 35 may be left to hang from the belt 20 via the dispensing hose 30 when not in use by the operator. A coiled spring hose orienting member at each end 31,32 of the coiled dispensing hose 30 may be used to maintain the dispensing hose 30 in a helical position and to prevent the dispensing hose 30 from being bent too frequently at the location of its connections, in order to prevent accelerated or untimely fracturing of the dispensing hose 30 at these locations.

The spray applicator 35 may be used to control the flow of fluid issuing from the present inventive system 10. The spray applicator 35 may be constructed in a variety of shapes, including but not limited to a pistol-style spray applicator 35, as depicted in FIGS. 1-3. The scope of the present invention does not require the use of any one particular spray applicator 35 configuration. For example, FIG. 4 depicts a cylindrical spray applicator 35 configuration having an internal nozzle tip 36. All varieties of spray applicator 35 configurations known within the art are within the scope of the present invention. Preferably, the spray applicator 35 may be comprised of a durable, scratch-resistant material. Additionally, the surface of the spray applicator 35 may be textured or contoured to provide the operator with a more ergonomic and/or easy-grip surface. For example, the outer surface of the spray applicator 35 may be knurled to facilitate grasping in the hand of the operator.

As depicted in FIGS. 1-4, the spray applicator may further comprise a nozzle tip 36. The nozzle tip 36 may provide the aperture from which fluid contained within the system 10 issues forth. Preferably, the nozzle tip 36 may have a plurality of adjustable positions, with each position providing for a different configuration of fluid dispersal such as a stream, a spray, a mist, and the like.

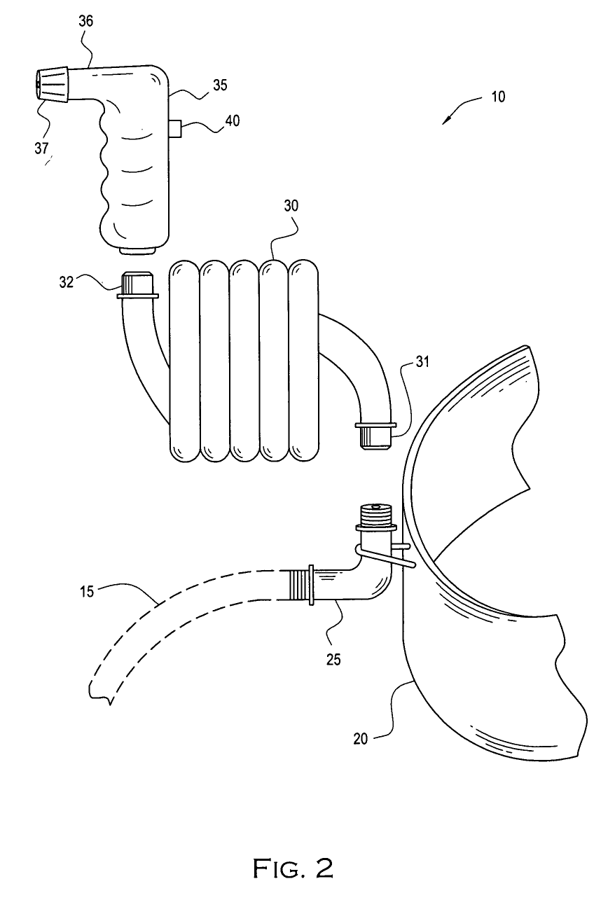

The spray applicator 35 may further comprise a variety of activation means. FIGS. 2-4 depict a push button 40 fluid activation means. The scope of the present invention is not limited to only such an embodiment, and may further include but is not limited to any activation means known within the art such as a button, lever, trigger handle, twist nozzle, and the like. Such capability may provide for painless use by individuals with arthritic conditions, carpal tunnel syndrome, and the like. Lack of such functionality may preclude such individuals from participating in any tasks requiring fluid application.

The system 10 of the present invention may further comprise a spray applicator holder 45 disposed on the belt 20. The shape of the holder 45 may be readily adapted to accommodate the particular spray applicator 35 employed. Suitable holders 45 may include but are not limited to clips, hooks, holsters, complimentary fasteners, and the like attached to the belt 20. FIG. 3 depicts a holster-type holder 45a attached to the belt 20. Such a holder 45 may be secured to the belt 20 in any means known within the art including but not limited to clips, rivets, fasteners, sliding the belt 20 through slots disposed within the holder 45, and the like. FIG. 4 depicts a complimentary fastener-type holder 45. As shown in FIG. 4, the complimentary fastener-type holder 45 may comprise embodiments such as a hook 45b secured to the belt 20 from which a ring element 45c secured on the spray applicator 35 may be hung.

The spray applicator holder 45 may be made from any material which has sufficient strength to retain the spray applicator 35 within the spray applicator holder 45. Such materials include but are not limited to nylon, plastic, vinyl, metal, rubber, and any combinations thereof. The spray application holder 45 may be permanently fixed to the belt 20 at a specific location or the holder 45 may be freely movable to any desired location on the belt 20. The ability to move the spray applicator holder 45 is highly beneficial so as to allow both right and left-handed operators to comfortably use the system 10 of the present invention. In accordance with each operator's unique preferences, the spray applicator holder 45 may be moved and secured to any position about the belt 20 desired by the operator.

As depicted in FIGS. 3 and 4, the system 10 of the present invention may further comprise at least one attachment 50 means disposed about the belt 20. The at least one attachment means 50 may include but is not limited to an enclosed pouch 50a, a strap 50b, a loop 50c, a pocket, and the like. By using at least one attachment means 50, an operator may keep additional items 55 (such as gardening tools 55a, construction tools 55b, and the like) close to their body while performing their work duties. Another example may include an enclosed pouch 50a for holding and protecting items such as a cell phone while an operator is using the fluid application system 10 of the present invention. The at least one attachment means 50, such as a strap 50b or loop 50c, may additionally be used as a point from which to hang and store the fluid application system 10 when not in use.

As depicted in FIG. 4, the present inventive fluid application system 10 may further comprise suspenders 60. The suspenders 60 may be utilized to further assist in securing the belt 20 about the waist or hips of the operator. Preferably the suspenders 60 may be adjustable and have a plurality of attachment points about the perimeter of the belt 20. Any configuration of suspenders 60 known within the art may be utilized to further assist in securing the present inventive system 10 about the torso of the operator. The suspenders 60 may be either permanently attached to the belt 20 or removably attached to the belt so that each operator may choose if additional suspender 60 support is required.

In use, one embodiment of the system 10 of the present invention may be attached to a conventional garden hose (fluid supply hose 15). A female threaded end of the fluid supply hose 15 may directly communicate with a threaded male connection on the connecting means 25. Alternatively, a quick release hose connection may releasably attach the connecting means 25 of the present system 10 to the fluid supply hose 15. The body of the connecting means 25 may comprise a 90 degree configuration with the connecting means 25 passing through an aperture disposed at the approximate midpoint of the belt 20 of the present invention. The connecting means 25 may further be secured to the belt 20 to prevent any further movement of the connecting means 25. The first end 31 of the coiled dispensing hose 30 may threadingly engage the connecting means 25 or, alternatively, have a quick release connection thereto. The second end 32 of the coiled dispensing hose 30 may threadingly engage the spray applicator 35 or, alternatively, have a quick release connection thereto. The spray applicator 35 may comprises a trigger-handle for actuating the release of fluid from the system 10. Additionally, a ring element 45c may be secured to the spray applicator 35 with the ring element 45c capable of being displaced over a hook 45b secured to the belt 20 when the spray applicator 35 of the system 10 is not in use by the operator.

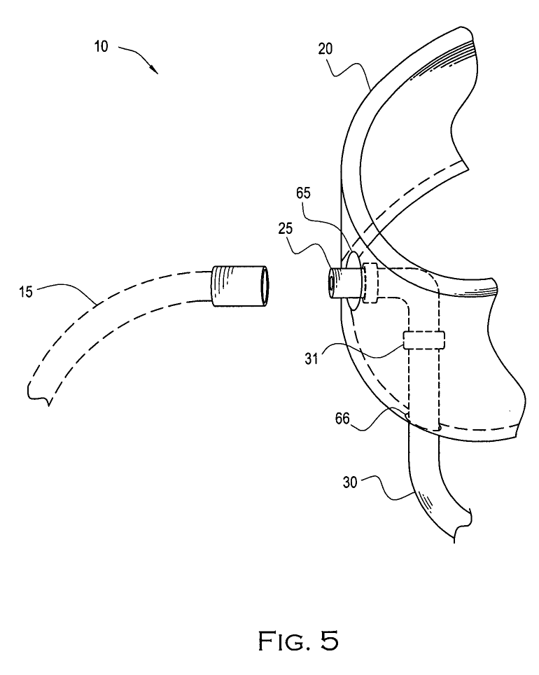

As depicted in FIG. 5, another embodiment of the system 10 of the present invention may comprise a plurality of components and connections disposed within the belt 20 to provide a more aesthetic and streamlined appearance. The connecting means 25 and the first end 31 of the dispensing hose 30 may be disposed within a space defined by the belt 20 and thus may be inaccessible to the operator. As shown in FIG. 5, a quick release mechanism attached to the connecting means 25 may protrude from the belt via a first aperture 65 and be capable of communicating with a complimentary quick release mechanism disposed about the end of the fluid supply hose 15. Additionally, the first end 31 of the dispensing hose may engage the connecting means 25 within the space defined by the belt 20. A portion of the dispensing hose 30 may exit from within the belt via a second aperture 66 to thereafter connect the second end 32 of the dispensing hose 30 to the spray applicator 35 (not shown).

As is readily apparent from the above description, the present invention provides a fluid application system 10 that allows an operator to conveniently transport a fluid supply hose 15 without the need to occupy their hands. Furthermore, the uniquely designed system 10 allows the operator to maintain both the fluid supply hose 15 and the spray applicator 35 close to their side while performing any other work related duties. When the operator moves about, the fluid supply hose 15 is dragged or pulled along by the operator's body, leaving their hands and arms free to direct the spray applicator 35, climb ladders, and the like. This arrangement is very convenient in elevated and/or mobile work environments where an operator may otherwise frequently become separated from the spray applicator 35 and/or continuously perform duties requiring the use of two free hands.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A fluid application system wherein a fluid is delivered to said fluid application system by a fluid supply hose, said fluid application system comprising:
a belt sized to secure said fluid application system around the waist or hip of an operator;
a connecting means secured to said belt, wherein said connecting means is in communication with and releasably secured to said fluid supply hose;
a dispensing hose having a first end and a second end, wherein said first end of said dispensing hose communicates with said connecting means; and
a spray applicator in communication with said second end of said dispensing hose.

2. The fluid application system of claim 1, further comprising:
at least one attachment means disposed about said belt for releasably retaining additional items around the waist or hip of said operator.

3. The fluid application system of claim 2, wherein said at least one attachment means is selected from the group consisting of a strap, a loop, a pocket, and a covered pouch.

4. The fluid application system of claim 1, further comprising:
suspenders attached to said belt to assist in the retention of said belt around said waist or hip of said operator, wherein said suspender attachment is selected from the group consisting of a permanent attachment and a removable attachment.

5. The fluid application system of claim 1, further comprising:
a spray applicator holder for securing said spray applicator when not in use, said spray applicator holder being fastened to said belt.

6. The fluid application system of claim 5, wherein said spray applicator holder is selected from the group consisting of a hook, a clip, a holster, a loop, and complimentary fasteners.

7. The fluid application system of claim 5, wherein said spray applicator holder is permanently fastened to said belt.

8. The fluid application system of claim 1, wherein said spray applicator further comprises a nozzle tip having a multi-positional head, said multi-positional head providing a plurality of spray configurations.

9. The fluid application system of claim 1, wherein said connecting means is secured to said belt at the approximate midpoint of said belt and adjacent the lower back region of said operator.

10. The fluid application system of claim 1, wherein said dispensing hose is a flexible coiled tube.

11. The fluid application system of claim 1, wherein a quick release mechanism releasably secures said fluid supply hose to said connecting means.

12. The fluid application system of claim 1, wherein said spray applicator further comprises a button for controlling fluid flow from said spray applicator.

13. A fluid application system wherein a fluid is delivered to said fluid application system by a fluid supply hose, said fluid application system comprising:
a belt sized to secure said fluid application system around the waist or hip of an operator;
a connecting means secured to said belt, wherein said connecting means is in communication with and releasably secured to said fluid supply hose, said connecting means comprising a quick release valve for releasably securing said fluid supply hose to said connecting means;
a dispensing hose having a first end and a second end, wherein said first end of said dispensing hose communicates with said connecting means, wherein said dispensing hose comprises a flexible coiled tube;
a spray applicator in communication with said second end of said dispensing hose; and
a spray applicator holder for securing said spray applicator when not in use, said spray applicator holder being attached to said belt, wherein said spray applicator holder is selected from the group consisting of a hook, a clip, a holster, a loop, and complimentary fasteners.

14. The fluid application system of claim 13, further comprising:
at least one attachment means disposed about said belt for releasably retaining additional items around said waist or hip of said operator, wherein said at least one attachment means is selected from the group consisting of a strap, a loop, a pocket, and a covered pouch.

15. The fluid application system of claim 13, further comprising:
suspenders attached to said belt to assist in the retention of said belt around the waist or hip of said operator, wherein said suspender attachment is selected from the group consisting of a permanent attachment and a removable attachment.

16. The fluid application system of claim 13, wherein said spray applicator comprises a nozzle tip having a multi-positional head providing a plurality of spray configurations.

17. The fluid application system of claim 13, wherein said connecting means is secured to said belt adjacent the lower back region of said operator.

18. The fluid application system of claim 13, wherein said spray applicator further comprises a button for controlling fluid flow from said spray applicator.

19. The fluid application system of claim 13, wherein said spray applicator holder is releasably fastened to said belt to accommodate fastening in a right-handed position or a left-handed position.

20. A fluid application system wherein a fluid is delivered to said fluid application system by a fluid supply hose, said fluid application system comprising:
a belt sized to secure said fluid application system around the waist or hip of an operator;
a connecting means secured to said belt, wherein said connecting means comprises a quick release mechanism in communication with and releasably secured to said fluid supply hose, said connecting means being secured to said belt adjacent the lower back region of said operator;
a dispensing hose having a first end and a second end, wherein said first end of said dispensing hose communicates with said connecting means, wherein said dispensing hose is a flexible coiled tube;
a spray applicator in communication with said second end of said dispensing hose, said spray applicator having a button for controlling fluid flow from a nozzle tip of said spray applicator, said nozzle tip comprising a multi-positional head providing a plurality of spray configurations;
at least one attachment means disposed about said belt for releasably retaining additional items around said waist or hip of said operator, wherein said at least one attachment means is selected from the group consisting of a strap, a loop, a pocket, and a covered pouch; and
a spray applicator holder for securing said spray applicator when not in use, said spray applicator holder being fastened to said belt, wherein said spray applicator holder is selected from the group consisting of a hook, a clip, a holster, a loop, and complimentary fasteners, said spray applicator holder being adjustably fastened to said belt to accommodate fastening said spray applicator holder in a right-handed position or a left-handed position.
